(19) United States
(12) Patent Application Publication
(10) Pub. No.: US 2025/0034046 A1
(43) Pub. Date: Jan. 30, 2025

(54) QUICK-DRYING LEVELLING COMPOUND FOR DECORATIVE FLOOR COVERINGS

(71) Applicant: SIKA TECHNOLOGY AG, Baar (CH)

(72) Inventors: Markus KNOEBEL, Coesfeld (DE); Nick SCHNEIDER, Billerbeck (DE)

(73) Assignee: SIKA TECHNOLOGY AG, Baar (CH)

(21) Appl. No.: 18/710,803

(22) PCT Filed: Nov. 23, 2022
(86) PCT No.: PCT/EP2022/082976

§ 371 Date: May 16, 2024

(30) Foreign Application Priority Data
Dec. 22, 2021 (EP) 21217189.6

(51) Int. Cl. C04B 28/16; C04B 24/38; C04B 28/06; C04B 28/14; C04B 111/60; E04F 15/12

(52) U.S. Cl. CPC C04B 28/16; C04B 24/383; C04B 28/065; C04B 28/146; E04F 15/12; C04B 2111/60

(57) ABSTRACT

A floor construction including a floor covering and a sealing layer applied to the floor covering, wherein one or more primers are arranged between the substrate and the floor covering and the floor covering is formed of a filling compound which includes an aluminate binder, a calcium sulfate binder, one or more fillers, ethyl hydroxyethyl cellulose as thickening agent, comb polymer having sidechains with an ionic group and sidechains with an ether group bonded to a polymer backbone, as plasticizer, and one or more color pigments as coloring agent.

### TECHNICAL FIELD

The present invention relates to a floor construction which comprises a floor covering, in particular a decorative floor covering, and a sealing layer applied to the floor covering, wherein the floor covering is formed with a filling compound based on calcium sulfate.

### PRIOR ART

Calcium sulfate-based filling compounds are used for smoothing and leveling screeds and other floors or surfaces and are also referred to as leveling compounds.

Flooring is one sector in which there is a tendency to use so-called binary and ternary binders for the formulation of building materials, e.g., screeds or filling compounds, or filling compounds. Binary binders comprise aluminate cement and calcium sulfate as hydraulic binders. Ternary binders additionally comprise Portland cement as a third hydraulic binder. Binary and ternary binders have the particular advantage of a reduced time until they are ready for covering as compared with standard cements. This means that it is possible within a shorter time to continue working, which is a key economic advantage.

For example, WO 2015/150319 A1 relates to quick-drying gypsum compositions based on calcium aluminate and calcium sulfate as hydraulic binders, in particular for use as a filling compound.

In many applications it is desirable that the filling compounds or leveling compounds based on calcium sulfate remain visible as a floor covering in the completed floor construction. Such decorative floor coverings are usually colored with the help of coloring agents such as color pigments and protected with a seal.

However, there is a problem that the appearance of colored floor coverings based on calcium sulfate does not meet the high requirements for decorative floor coverings, especially if the floor covering is to have a darker color. Frequently, defects such as so-called oil eyes, fine holes and streaking and, overall, an uneven coloring can be detected on the floor covering formed. Cracks are also possible.

### SUMMARY OF THE INVENTION

The object of the present invention is to provide a floor construction with a floor covering based on calcium sulfate, in particular a decorative floor covering, which shows a uniform coloring, especially in darker colors, and can thus be used as an aesthetically sophisticated decorative floor covering. In particular, visible defects such as so-called oil eyes, fine holes and streaking should be avoided as far as possible. In addition, the applied floor covering is to dry quickly and thus enable rapid further processing.

The inventors have found that this object can be achieved by producing the floor covering using a filling compound based on aluminate cement and calcium sulfate, to which a specific cellulose ether is added as a thickening agent and a specific plasticizer as an additive.

The invention therefore relates to a floor construction on a substrate, comprising a floor covering, in particular a decorative floor covering, and a sealing layer applied to the floor covering, wherein one or more primers are arranged between the substrate and the floor covering and the floor covering is formed of a filling compound mixed with water and cured, wherein the filling compound comprises
i) an aluminate binder selected from calcium aluminate cement and/or calcium sulfoaluminate cement,
ii) a calcium sulfate binder selected from calcium sulfate hemihydrate and/or calcium sulfate anhydrite,
iii) one or more fillers,
iv) ethyl hydroxyethyl cellulose as thickening agent,
v) comb polymer, which is a copolymer comprising a polymer backbone and sidechains bonded thereto, and at least one ionizable monomer unit M1 and at least one sidechain-bearing monomer unit M2 are present, wherein the ionic group of the ionizable group is selected from carboxylate, sulfonate, phosphate or phosphonate and the sidechain-bearing monomer unit M2 contains at least one ether group, as plasticizer, and
vi) one or more color pigments as coloring agent,

wherein the amount of filler is 15% to 70% by weight and the total amount of aluminate binder and calcium sulfate binder is 25% to 80% by weight, wherein the weight ratio of aluminate binder to calcium sulfate binder is in the range from 1:1 to 1:8, wherein the weight specifications refer to the dry weight of the filling compound.

The floor construction according to the invention comprises a floor covering with a very uniform coloring, especially in darker colors, and is suitable as a decorative floor covering. Defects such as oil eyes, fine holes and streaking are detected not at all or only to a small extent. The color pigments are distributed homogeneously in the floor covering. The floor covering is also quick-drying, so that a seal is possible after just a relatively short time, e.g., after 48 h at the latest.

Other advantages of the invention are:
low shrinkage of the filling compound during drying
good mechanical properties of the floor covering, e.g., in terms of compressive and bending strength
rapid early strength
low pH of the filling compound (pH<11.5)
use of alternative binders instead of Portland cement, which is ecologically advantageous, in particular lower CO₂ footprint compared to classic cement-based binder systems
the floor covering has few to no fine holes, which are otherwise often caused by the thickening agent used
no additional defoamer is necessary, as the plasticizer used also has a defoaming effect
pigment fraction can be reduced
the filling compound, mixed with water, is pumpable.

### WAYS OF EXECUTING THE INVENTION

The invention relates to a floor construction on a substrate, wherein the floor construction comprises a floor covering and a sealing layer applied to the floor covering, wherein one or more primers are arranged between the substrate and the floor covering.

The floor covering is a decorative floor covering in particular, i.e., the floor covering is visible after completion of the floor construction. It is preferably a colored floor covering, in particular a dark-colored floor covering. Examples of colors of the floor covering are white, black, gray, chromatic or a mixture thereof, with suitable chromatic colors being, for example, blue, purple (or violet), red, dark red, yellow, orange or pink, green or brown or in-between shades of these. Black, gray and white floor coverings are particularly preferred. As indicated, the floor covering of the floor construction according to the invention is characterized by a very uniform or homogeneous coloring largely without defects.

The floor covering or decorative floor covering is formed of a filling compound mixed with water and cured. The filling compound is in particular a solid filling compound, e.g., in the form of a powder.

The filling compound comprises
i) an aluminate binder selected from calcium aluminate cement and/or calcium sulfoaluminate cement,
ii) a calcium sulfate binder selected from calcium sulfate hemihydrate and/or calcium sulfate anhydrite,
iii) one or more fillers,
iv) ethyl hydroxyethyl cellulose as thickening agent,
v) comb polymer, which is a copolymer comprising a polymer backbone and sidechains bonded thereto, and at least one ionizable monomer unit M1 and at least one sidechain-bearing monomer unit M2 are present, wherein the ionic group of the ionizable group is selected from carboxylate, sulfonate, phosphate or phosphonate and the sidechain-bearing monomer unit M2 contains at least one ether group, as plasticizer, and
vi) one or more color pigments as coloring agent.

The aluminate binder is calcium aluminate cement and/or calcium sulfoaluminate cement. The aluminate binder is preferably calcium sulfoaluminate cement. The aluminate binder is a hydraulic binder.

In one embodiment, the aluminate binder comprises at least one calcium aluminate cement (CAC). A calcium aluminate cement (CAC) according to the present invention is in particular a cement comprising a clinker which comprises hydraulic calcium aluminates, the main phase being preferably CA (C: CaO; A: Al₂O₃). Other calcium aluminates, such as C₂A, C₃A, and C₁₂A₇, for example, are typically likewise present. CACs for the present invention may typically also contain other phases, selected from gehlenite (C₂AS with C: CaO, A: Al₂O₃, S: SiO₂), perovskite (CT with C: CaO, T: TiO₂), belite (C₂S with C: CaO, S: SiO₂), tricalcium silicate, ferrites (C₂F, C₂AF, C₄AF with C: CaO; A: Al₂O₃; F: Fe₂O₃), ternesite (CsS₂$ with C: CaO, S: SiO₂; $: SO₃) and aluminum oxide. CACs of the present invention may additionally contain calcium carbonate. In particular, a CAC of the present invention preferably conforms to the standard EN 14647. Equally suitable are CACs described in other standards, e.g., ASTM or Chinese standards. Suitable CACs may be obtained commercially for example from Royal White Cement.

In one embodiment, the aluminate binder comprises at least one calcium sulfoaluminate (CSA) cement. According to the present invention, a CSA cement is, in particular, a cement comprising a clinker which comprises C₄(A₃₋ₓFₓ)$ (C: CaO; A: Al₂O₃; F: Fe₂O₃; $: SO₃), where x is an integer 0-3. CSAs for the present invention may typically contain further phases, selected from aluminates (CA, C₃A, C₁₂A₇, with C: CaO; A: Al₂O₃), belite (C₂S, with C: CaO, S: SiO₂), ferrites (C₂F, C₂AF, C₄AF, with C: CaO; A: Al₂O₃; F: Fe₂O₃), ternesite (CsS₂$ with C: CaO, S: SiO₂; $: SO₃) and anhydrite. In certain embodiments of the invention, the CSA contains 15-75% by weight C₄A₃$, 0-10% by weight aluminates, 0-70% by weight belite, 0-35% by weight ferrites, 0-20% by weight ternesite, and 0-25% by weight anhydrite, based in each case on the total dry weight of the CSA cement. Any anhydrite present is part of the CSA cement and is to be included therein. Suitable CSAs may be obtained for example under the trade name Calumex from Caltra B.V.

The calcium sulfate binder is a hydraulic binder. The calcium sulfate binder is selected from calcium sulfate hemihydrate (CaSO₄·½H₂O) and/or calcium sulfate anhydrite (CaSO₄), with calcium sulfate hemihydrate being preferred.

Calcium sulfate anhydrite is anhydrous calcium sulfate (no water of crystallization). Calcium sulfate hemihydrate comprises alpha-calcium sulfate hemihydrate and beta-calcium sulfate hemihydrate, with calcium sulfate hemihydrate being preferred.

In relation to the calcium sulfate binders, it is preferred for it to consist substantially or completely of calcium sulfate hemihydrate, since too high a proportion of anhydrite results in excessively rapid uptake of water by the anhydrite constituent, which may affect the processability of the composition. As a result, it is preferred if at least 80% by weight of the total amount of calcium sulfate binder, preferably at least 90% by weight, and particularly preferably at least 95% by weight, is accounted for by the calcium sulfate hemihydrate (balance: calcium sulfate anhydrite).

Calcium sulfate dihydrate (CaSO₄·2H₂O) is incapable of binding water and so is not included here within the calcium sulfate binder. However, calcium sulfate dihydrate may also possibly be contained in the filling compound. Calcium sulfate dihydrate may act as a “nucleating agent” and produces a faster reaction of the calcium sulfate hemihydrate. The filling compound therefore preferably comprises calcium sulfate dihydrate.

The filling compound also contains one or more fillers, also referred to as aggregates. These may be any solid material which is inert for the hydration reaction of the hydraulic binder. Fillers or aggregates used may be the substances known in the field to the person skilled in the art. Examples of fillers or aggregates are rock, chippings, gravel, slag, ground rock, recycled aggregate, recycled concrete, sand, such as quartz sand or river sand, ground rock, glass, expanded glass, hollow glass beads, glass-ceramics, volcanic rock, pumice stone, perlite, vermiculite, porcelain, electromelted or sintered abrasives, firing aids, silicon dioxide xerogels, carbonates, such as ground limestone, ground dolomite and chalk, and/or ground aluminum oxide.

It is possible to use solid materials for which opportunities for (re)utilization are being sought. Examples of such fillers or aggregates are:
(i) materials of biological origin, preferably plant origin, especially materials of plant origin consisting substantially of cellulose and/or lignin
(ii) synthetic non-mineral materials, preferably selected from thermoplastics or thermosets, elastomers, rubbers, textile fibers, and plastics materials reinforced with glass or carbon fibers
(iii) inorganic aggregates from the demolition of structural and civil engineering edifices, preferably selected from concrete wastes, mortar, brick, natural stone, asphalt, tiles, shingles, aerated concrete, clinker, and metal scrap (iv) organic aggregates from the recycling of industrial products, especially difficult-to-recycle composite materials, more particularly recycled insulating materials
(v) granular materials presenting no health concerns and normally intended for landfill, such as used foundry sands, catalyst supports, clinker adjuvants, fillers from the treatment of excavation sludge, sewage sludge, liquid manure, paper wastes, paper combustion ash, household garbage combustion ash.

In a preferred embodiment, the one or more fillers or aggregates comprise or are sand and/or carbonatic fillers, preferably in the form of calcium carbonate. Suitable sands are described for example in the standards ASTM C778 or EN 196-1. Calcium carbonate also embraces limestone and chalk. The sand may in particular be quartz sand or river sand.

A suitable quartz sand has a grading curve for example within a range from about 0 to 0.5 mm, preferably within a range from about 0.08 to 0.4 mm. A further suitable quartz sand has a particle size for example within a range from about 0.1 to 1 mm, preferably from about 0.2 to 0.8 mm.

A suitable calcium carbonate has for example a mean particle diameter in the region of 2.5 μm and a grading line with absence of residue of about 40 μm. A suitable limestone flour has a fineness for example of <0.1 mm.

In the following, the weight specifications relating to the filling compound refer to the dry weight of the filling compound, unless otherwise indicated.

The total amount of aluminate binder and calcium sulfate binder in the filler is 25% to 80% by weight, preferably 30% to 75% by weight, more preferably 40% to 70% by weight.

The weight ratio of aluminate binder to calcium sulfate binder in the filling compound is in the range from 1:1 to 1:8, preferably in the range from 1:1.6 to 1:4, more preferably 1:2 to 1:3.5. The weight ratio of aluminate binder to calcium sulfate binder is particularly preferably in the range from 1:2.1 to 1:3. The amount of filler in the filling compound is 15% to 70% by weight, preferably 25% to 60% by weight.

In a preferred embodiment, the filling compound comprises:
i) 10% to 30% by weight of the aluminate binder,
ii) 20% to 60% by weight, preferably 30% to 55% by weight, of the calcium sulfate binder and
iii) 15% to 70% by weight, preferably 25% to 60% by weight, of the one or more fillers.

The filling compound also contains iv) ethyl hydroxyethyl cellulose as thickening agent. One or more ethyl hydroxyethyl celluloses can be used. Such cellulose ethers are commercially available. An ethyl hydroxyethyl cellulose whose use is preferred is, for example, Bermocoll® E 230 X from Nouryon HQ, Netherlands.

The ethyl hydroxyethyl cellulose preferably has a fine particle size, e.g., a particle size d₉₈ of not more than 1000 μm, preferably not more than 600 μm. For example, Bermocoll® E 230 X has a particle size d₉₈ of not more than 425 μm (98% of the particles ≤425 μm).

The particle size can be determined presently by laser diffraction as described in ISO 13320:2009. In particular, a Mastersizer 2000 device with a Hydro 2000G dispersion unit and the Mastersizer 2000 software from Malvern Instruments GmbH (Germany) is used. Isopropanol, for example, is a suitable measuring medium. Preferably, the particle size of non-spherical or irregular particles is represented by the equivalent sphere diameter of a sphere having the same volume. A particle size d₉₈ here corresponds to the particle size at which 98% by weight of all the particles are smaller.

The content of cellulose ether in the filling compound is preferably in the range from 0.01% to 0.2% by weight, more preferably 0.02% to 0.1% by weight, based on the dry weight of the filling compound.

The cellulose ether used according to the invention forms only a few fine holes or none at all, in contrast to thickening agents usually used; in this way, the appearance of the floor covering can be significantly improved.

The filling compound also contains v) comb polymer, which is a copolymer that comprises a polymer backbone and sidechains bonded thereto, and at least one ionizable monomer unit M1 and at least one sidechain-bearing monomer unit M2 are present, wherein the ionic group of the ionizable group is selected from carboxylate, sulfonate, phosphate or phosphonate and the sidechain-bearing monomer unit M2 contains at least one ether group, as plasticizer.

Such comb polymers are described for example in WO 2017/050896 A1. In the comb polymers described in this patent application, the comb polymer or copolymer in a direction along the polymer backbone has a non-random distribution of the sidechains with an ionic group and the sidechains with at least one ether group, wherein the sidechains of the copolymer preferably in at least one section have a gradient structure and/or a block structure. According to the invention, copolymers with such a distribution of the sidechains can be used. However, corresponding comb polymers can also be used which do not have a block or gradient structure but in which the sidechains are distributed statistically on the polymer backbone.

One or more comb polymers can be used. Comb polymers in which the ionic group is a carboxylate group are preferred. The comb polymer is therefore preferably a polycarboxylate ether (PCE). Such plasticizers, especially PCE plasticizers, are known to the person skilled in the art. They are also referred to as “superplasticizers”.

The comb polymer is preferably a copolymer, wherein in the copolymer an incorporated ionizable monomer unit M1 has a structure of the formula I,

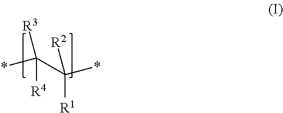

and the sidechain-bearing monomer unit M2 contains a structure of the formula II

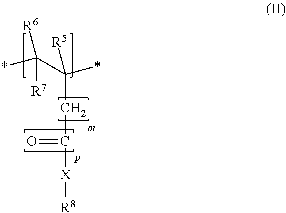

where
R¹, in each case independently, is —COOM, —SO₂—OM, —O—PO(OM)₂ and/or —PO(OM)₂,
R², R³, R⁵ and R⁶, in each case independently, are H or an alkyl group having 1 to 5 carbon atoms,
R⁴ and R⁷, in each case independently, are H, —COOM or an alkyl group having 1 to 5 carbon atoms,
or where R¹ with R⁴ can form a ring to —CO—O—CO—,
M, independently of one another, represents H⁺, an alkali metal ion, an alkaline earth metal ion, a di- or trivalent metal ion, an ammonium ion or an organic ammonium group;
m=0, 1 or 2,
p=0 or 1,
X, in each case independently, is —O— or —NH—,
R⁸ is a group of the formula -[AO]ₙ—R^{a},
   where A=C₂- to C₄-alkylene, R^{a} is H, a C₁- to C₂₀-alkyl group, -cycloalkyl group or -alkylaryl group,
and n=2-250, especially 10-200.

The molar ratio of the monomer units M1 to the monomer units M2 in the copolymer can be in the range of 0.5-6, in particular 0.7-4, preferably 0.9-3.8, further preferably 1.0-3.7 or 2-3.5.

It is preferred that R¹=COOM; R² and R⁵, independently of each other, stand for H, —CH₃ or mixtures thereof; R³ and R⁶, independently of each other, stand for H or —CH₃, preferably for H; R⁴ and R⁷, independently of each other, stand for H or —COOM, preferably for H; and wherein X stands for —O— in at least 75 mol %, in particular in at least 90 mol %, especially in at least 99 mol % of all monomer units M2.

The copolymer may optionally contain further monomer units, which are different from M1 and M2.

The content of comb polymer in the filling compound is preferably in the range from 0.05% to 0.5% by weight, more preferably 0.1% to 0.3% by weight, wherein the weight specifications refer to the dry weight of the filling compound.

The comb polymer also has a defoaming function. Therefore, it is not necessary to include an additional defoamer in the formulation. Defoamers are usually used to diminish the air bubbles during the mixing operation and to reduce or eliminate them as quickly as possible afterwards. This minimizes adverse properties such as reduction in strengths and inconsistent surface appearance. In particular, the irritation caused by so-called “pinholes” (pinprick-like air bubbles) ensures that subsequent coatings can also only be applied with the appearance of blistering.

It is an advantage that no additional defoamer usage is required, as this eliminates the task of finding tolerant and mutually compatible plasticizers and defoamers. Especially when appearance requirements are exacting, there is a problem here, as not all systems are compatible with each other.

Commonly used defoamers have the disadvantage of conveying the color pigments contained in the filling compound to the surface of the filling compound, which can lead to an uneven distribution. This can cause surface defects such as oil eyes or uneven pigmentation.

The filling compound therefore preferably contains essentially no defoamers, e.g., less than 0.1% by weight; in particular the filler is preferably free of defoamer. The defoamers are more particularly silicone-containing and silicone-free polymers or based on mineral oil and/or polyglycol, which have a defoaming effect. The comb polymer used is not regarded here as a defoamer.

The filling compound further comprises vi) one or more color pigments as coloring agent. The one or more color pigments are used to give the floor covering the desired coloring. In contrast to fillers, they have a high opacity, so that they allow a homogeneous coloring of the floor covering even in relatively small quantities (e.g., less than 4% by weight).

In a preferred embodiment, the one or more color pigments are selected from white color pigments, black color pigments, chromatic color pigments or mixtures thereof. Gray hues can be obtained, for example, by mixing white and black pigments. Suitable chromatic colors are for example blue, purple (or violet), green, brown, red, yellow, orange or pink pigments. Dark tones can be achieved by mixing with black pigments. The one or more color pigments are preferably black color pigments, but all other color pigments are also conceivable.

Examples of suitable color pigments are inorganic or organic pigments, e.g., metal oxides and mixed metal oxides, such as titanium dioxide, chromium oxide, iron oxide, mixed iron manganese oxide, or carbon black. The products from the XFast® range from BASF, Germany, are examples of suitable color pigments.

The total fraction of color pigments in the filling compound can be, for example, in the range from 0.01% to 4% by weight, preferably 0.1% to 2% by weight.

In addition to the additives stated, the filling compound may also contain one or preferably two or more other additives.

In a preferred embodiment, the filling compound further comprises at least one polyol having a functionality of 4 or less and a density of OH groups of at least 0.033 mol OH per g polyol. A polyol has at least 2 hydroxyl groups. The at least one polyol is preferably glycerol and/or erythritol, preferably erythritol.

Preferably only one such polyol is used.

It is known that compositions based on binary or ternary binders may also be subject commonly to shrinkage during the setting and drying process. Such shrinkage is deleterious to the functionality, as it may, for example, frequently be the cause of cracks forming or of screeds bulging. It has emerged that the use of at least one aforesaid polyol results in a particularly large reduction in shrinkage.

The at least one polyol, preferably glycerol and/or erythritol, is present preferably in an amount of 0.5% to 10% by weight, more preferably 1.2% to 6.5% by weight, based on the weight of the aluminate binder. It has been found that the reduction in shrinkage is particularly pronounced at such polyol dosage levels.

In a preferred embodiment, the filling compound further comprises at least one lithium salt, which accelerates the curing of the composition. Suitable lithium salts are, for example, lithium sulfate and lithium halides, especially lithium chloride, and also lithium carbonate. The most preferred is lithium carbonate.

The lithium salt, in particular lithium carbonate or lithium sulfate, is preferably contained in an amount of 0.001% to 0.5% by weight, more preferably 0.005% to 0.05% by weight, in the filling compound. At less than 0.001%, the concentration is generally too low to produce any notably accelerating effect, whereas an addition of more than 0.5% by weight may lead to excessively rapid curing of the composition.

In a preferred embodiment, the filling compound further contains tartaric acid and/or a tartaric acid salt, preferably an alkali metal salt of tartaric acid, preferably in an amount of 0.15% to 0.005% by weight, more preferably 0.1% to 0.01% by weight, particularly preferably 0.08% to 0.015% by weight. Preference is given to sodium or potassium tartrate or to the mixed salt sodium/potassium tartrate.

The addition of tartaric acid and/or a tartaric acid salt has positive effects on the expansion behavior of the filling compound by suppressing excessive expansion of the material. To achieve such an effect, at least 0.005% by weight is generally used, while more than 0.15% by weight can lead to excessively severe retardation of setting.

In a particularly preferred embodiment, the filling compound contains all of the additives mentioned above. The filling compound may also contain other common additional additives, e.g., curing retarders and/or flexibilizing agents.

The total concentration of such additional additives is, for example, less than 10% by weight, preferably less than 5% by weight and more preferably less than 3% by weight, conveniently in the range from about 0.1% to 10% by weight, preferably about 0.5% to 5% by weight, more preferably about 1% to 3% by weight.

Examples of suitable flexibilizers are organic polymers, based for example on vinyl acetate and ethylene, which are available, for example, as Vinnapas®5025 L from Wacker. A suitable retarder is available for example under the trade name Retardan® P from Sika Schweiz AG. Further suitable retarders are sodium gluconate, or sodium citrate.

The filling compound may also contain Portland cement, but this is generally not preferred. For example, the filling compound may contain up to 5% by weight, preferably not more than 3% by weight, more preferably not more than 1% by weight, in particular not more than about 0.1% by weight of Portland cement. However, the filling compound is preferably free of Portland cement.

The filling compound is also preferably free of other activators, in particular calcium hydroxide, sodium hydroxide, potassium hydroxide, alkali metal waterglasses and mixtures thereof. Such activators, especially Portland cement, act as bases and influence the pH.

Another possible additive is potassium sulfate. Potassium sulfate actively influences the formation of gypsum in the presence of calcium sulfate. This results in accelerated phase formation and usually a reduction in the swelling process.

The quantities of the individual constituents in the filling compound may also depend on the type of application and the applied layer thickness.

An advantageous embodiment of the filling compound according to the invention contains
10% to 25% by weight of aluminate binder,
30% to 60% by weight of calcium sulfate hemihydrate,
5% to 12% by weight of calcium carbonate, e.g., chalk and/or limestone, as filler,
10% to 40% by weight of quartz sand,
0.01% to 0.10% by weight of potassium sodium tartrate,
0.005% to 0.5% by weight of lithium salt, especially lithium carbonate or lithium sulfate.

The filling compounds of the present invention are, in particular, dry compositions, but they may contain a residual fraction of water. The content of water in filling compounds of the present invention is usually less than 3% by weight, preferably less than 2% by weight, more preferably less than 1% by weight, each based on the total mass of the filling compound. Dry filling compounds of this kind have improved storage stability.

The thickness of the floor covering/filling compound may vary depending on particular application. In general, the floor covering, in particular the decorative floor covering, preferably has a layer thickness in the range from 1 to 100 mm, more preferably 5 to 75 mm, particularly preferably 3 to 30 mm.

Further information on the production of the floor covering from the filling compound is given below with regard to the method according to the invention.

In the floor construction according to the invention, a sealing layer is arranged on the floor covering, in particular the decorative floor covering. Such seals are customary in the field of floor constructions and the common sealing layers can be used.

The sealing layer is used to protect the floor covering, e.g., from dust, dirt or discoloration, thereby protecting the attractive decorative effect.

The sealing layer is preferably transparent or translucent. It is also, alternatively or additionally, colorless. It can be matt or glossy, for example.

For example, a plastic seal is suitable as a sealing layer, in which case an epoxy resin seal or a polyurethane seal is preferred.

The sealing layer can be applied directly to the floor covering to be protected.

However, it is also possible to arrange a primer between the floor covering and the sealing layer. The primer can provide improved adhesion between the sealing layer and the floor covering.

For example, the primer can be applied at 50 to 200 g/m², 75 to 150 g/m². One, two or more such primers can be applied on top of each other.

In the floor construction according to the invention, one or more primers are arranged between the substrate and the floor covering. The common primers known to the person skilled in the art can be used, e.g., plastic dispersions or two-component binders. A suitable primer is a plastic primer, e.g., an epoxy resin primer. For example, an acrylate primer is also suitable as a primer, especially as a preprimer.

An epoxy resin primer is particularly preferred. This ensures the least possible interference from the substrate to the filling compound, e.g., with regard to blistering.

If necessary, the primer can be dusted. Quartz sand, for example, is suitable for dusting. The dusting material is in this case spread onto the applied, still fresh primer. Such dusting is known to the person skilled in the art.

In a preferred embodiment, the substrate may be provided with a preprimer, preferably an acrylate primer, and then with one or more primers, preferably epoxy resin primer(s), in which case the primer is particularly preferably dusted.

The primer or dusted primer is advantageous because it promotes the achievement of a uniform coloring of the floor covering. In particular, the primer can further reduce optical defects in the floor covering such as fine holes in the decorative layer and irregularities in the coloring. Epoxy resin primers, and epoxy resin primers which have been dusted with quartz sand (e.g., particle size 0.2 to 0.8 mm), have proved to be particularly favorable.

The substrate to which the filling compound is applied after a pretreatment with one or more primers is not subject to any restrictions. Examples of suitable substrates are concrete substrates, screeds, old substrates with ceramic coverings, old substrates based on screeds or concrete. The substrate is preferably a substrate based on cement, such as Portland cement, or on calcium sulfate. The substrate is preferably a substrate of concrete, screed or rapid screed.

The floor construction according to the invention thus comprises at least one primer on the substrate, the primer having been optionally dusted on, wherein the primer is preferably an epoxy resin primer, above the primer the floor covering, in particular the decorative floor covering, and a sealing layer, e.g., an epoxy resin layer or a polyurethane layer, as a protective layer over the floor covering.

The floor construction according to the invention is preferably a flooring construction, especially for the interior area. The floor construction is particularly suitable for floors of living rooms and/or sales areas of shop premises.

The invention also relates to the use of a filling compound for the production of a floor covering, in particular a decorative floor covering, on a substrate provided with one or more primers, wherein the filling compound comprises
i) an aluminate binder selected from calcium aluminate cement and/or calcium sulfoaluminate cement,
ii) a calcium sulfate binder selected from calcium sulfate hemihydrate and/or calcium sulfate anhydrite,
iii) one or more fillers,
iv) ethyl hydroxyethyl cellulose as thickening agent,
v) comb polymer, which is a copolymer comprising a polymer backbone and sidechains bonded thereto, and at least one ionizable monomer unit M1 and at least one sidechain-bearing monomer unit M2 are present, wherein the ionic group of the ionizable group is selected from carboxylate, sulfonate, phosphate or phosphonate and the sidechain-bearing monomer unit M2 contains at least one ether group, as plasticizer, and
vi) one or more color pigments as coloring agent,

wherein the amount of filler is 15% to 70% by weight and the total amount of aluminate binder and calcium sulfate binder is 25% to 80% by weight, wherein the weight ratio of aluminate binder to calcium sulfate binder is in the range from 1:1 to 1:8, wherein the weight specifications refer to the dry weight of the filling compound.

The above information with regard to the floor construction according to the invention applies in the same way with regard to the use according to the invention, in particular with regard to the design of the filling compound, the floor covering, the primer, the sealing layer and the substrate, and so reference is made to that information.

The use according to the invention is particularly suitable for the production of a decorative floor covering with uniform surface coloring. Overall, a homogeneous coloring of the floor covering is achieved. Reference is made to the above information.

The use according to the invention is particularly suitable in the context of a floor construction according to the invention as described above.

The invention further relates to a method for producing a floor construction according to the invention on a substrate as described above, wherein the method comprises the following steps:
a) applying one or more primers to the substrate,
b) applying a mixture of the filling compound with water to the primed substrate and allowing the mixture to dry, to form the floor covering, and
c) applying a sealing layer to the dried floor covering.

The above information with regard to the floor construction according to the invention applies in the same way with regard to the method according to the invention, in particular with regard to the design of the filling compound, the floor covering, the primer, the sealing layer and the substrate, and so reference is made to that information.

The substrate is provided with one or more primers before application of the filling compound according to step a). The primer, also known as priming coat, is applied to the substrate, e.g., by spreading. Pretreatment of this kind is known to the person skilled in the art.

Common primers can be used, e.g., plastic dispersions or two-component primers based on organic binders. An example is a two-component epoxy resin binder as a primer. The primer can be applied to the substrate by ordinary coating processes.

It may be useful to dust the one or the two or more primers applied. A suitable dusting material is quartz sand.

In the method according to the invention, the filling compound is mixed with water in step b). The fresh filling compound mixed with water can be fluid or pasty. In one embodiment, the filling compound may be self-leveling.

As the filling compound contains hydraulic binders in the form of aluminate binders and calcium sulfate binders, hydration reactions take place after the addition of water, as is known. By drying or setting, over time, the filling compound cures. Application to the primed substrate is performed when the filling compound is still fluid or pasty.

The consistency and the rheological behavior of the filling compound can be adjusted not only by the choice of additives used, but also in particular by the mixing ratio of filling compound and water. It is preferred to mix the filling compound with water in a mass ratio of water to filling compound in the range from 0.08 to 0.40, preferably 0.10 to 0.30, in particular 0.15 to 0.23. The resulting filling compound is advantageously pumpable, which facilitates transport.

The filling compound mixed with water is then applied to the primed substrate. The application can be done by any means known to the person skilled in the art, e.g., by means of a trowel, rake, doctor blade or roller, by casting or by means of squirting or spraying processes, preferably by means of a trowel, doctor blade, casting or rake. After application, the application mass is conveniently smoothed, e.g., with a finishing trowel.

After application of the filling compound to the substrate pretreated with one or more primers, the filling compound is allowed to dry. An advantage of the method according to the invention is that the filling compound dries quickly, so that after a relatively short drying period, e.g., at the latest after 48 hours, further processing of the floor covering formed is possible or readiness for covering is attained, especially in order to apply the sealing layer.

According to step c) of the method according to the invention, a sealing layer is applied to the dried floor covering. If necessary, the floor covering can be primed before application of the sealing layer. The sealing layer is preferably a plastic seal, in which case an epoxy resin seal or a polyurethane seal is preferred.

The sealing layer can be applied to the floor covering, for example, by conventional coating methods. As a coating material, polymer dispersions or reactive resins, e.g., in the form of two-component systems, can preferably be used for the production of the sealing layer. The seal can be formed by applying the coating material to the floor covering one or more times.

The invention also relates to a filling compound for the production of a floor covering, in particular a decorative floor covering, on a primed substrate, wherein the filling compound comprises
i) an aluminate binder selected from calcium aluminate cement and/or calcium sulfoaluminate cement,
ii) a calcium sulfate binder selected from calcium sulfate hemihydrate and/or calcium sulfate anhydrite,
iii) one or more fillers,
iv) ethyl hydroxyethyl cellulose as thickening agent,
v) comb polymer, which is a copolymer comprising a polymer backbone and sidechains bonded thereto, and at least one ionizable monomer unit M1 and at least one sidechain-bearing monomer unit M2 are present, wherein the ionic group of the ionizable group is selected from carboxylate, sulfonate, phosphate or phosphonate and the sidechain-bearing monomer unit M2 contains at least one ether group, as plasticizer, and
vi) one or more color pigments as coloring agent,

wherein the amount of filler is 15% to 70% by weight and the total amount of aluminate binder and calcium sulfate binder is 25% to 80% by weight, wherein the weight ratio of aluminate binder to calcium sulfate binder is in the range from 1:1 to 1:8, wherein the weight specifications refer to the dry weight of the filling compound.

The above information on the filling compound used in the floor construction according to the invention applies in the same way with regard to the filling compound according to the invention, and so reference is made to that information.

The invention is elucidated in more detail hereinbelow with reference to exemplary embodiments. The examples are provided by way of illustration and are not intended to limit the present invention in any way.

### WORKING EXAMPLES

### Example 1

### Formulations 1 to 5

Filling compounds were produced according to the formulations 1 to 5 specified in Table 1 below. Table 1 specifies the percentage weight fractions of the ingredients, based on the weight of the filling compound. Formulations 1 and 2 are filling compounds which are not according to the invention. Formulations 3 to 5 are filling compounds according to the invention.

Formulation 1 does not contain any color pigments. Formulations 3 to 5 result in gray, light gray or whitish gray colored floor coverings.

TABLE 1
Filling compound formulations 1-5

| | | 1* | | | 4 | 5 |
|---|---|---|---|---|---|---|
| | | (non- | 2* | 3 | (light | (whitish |
| | | pigmented) | (pigmented) | (gray) | gray) | gray) |
| Component | Function | % by wt. | % by wt. | % by wt. | % by wt. | % by wt. |
| Calcium sulfate dihydrate | | 1.000 | 1.000 | 0.250 | 0.250 | 0.250 |
| Polyvinyl alcohol | Anti-blocking agent | 1.500 | 1.500 | | | |
| Vinyl acetate-ethylene copolymer | Redispersible powder | | | 1.500 | 1.500 | 1.500 |
| Potassium sodium tartrate | Retarder | 0.050 | 0.050 | 0.030 | 0.020 | 0.020 |
| Potassium sulfate, ultra-fine | Nucleating agent | 0.250 | 0.250 | | | |
| Sodium gluconate powder | Retarder | | | 0.080 | 0.090 | 0.090 |
| Lithium carbonate 99% | Accelerator | | | 0.010 | 0.010 | 0.010 |
| Erythritol | Shrinkage reducer | | | 0.250 | 0.250 | 0.250 |
| Chalk | Filler | 10.000 | 10.000 | 7.500 | 7.500 | 7.500 |
| Quartz sand | Filler | 14.215 | 14.215 | 24.517 | 24.925 | 25.225 |
| alpha-Calcium sulfate hemihydrate | Binder | 50.000 | 50.000 | 46.200 | 46.200 | 46.200 |
| Modified amino acid | Retarder | 0.060 | 0.060 | | | |
| PCE type 1 | Plasticizer | 0.150 | 0.150 | | | |
| PCE type 2 | Plasticizer | | | 0.200 | 0.200 | 0.200 |
| Calcium aluminate | Binder | 2.000 | 2.000 | | | |
| Calcium sulfoaluminate | Binder | | | 17.750 | 17.750 | 17.750 |
| Hydroxyethyl cellulose type 1 | Thickener | 0.045 | 0.045 | | | |
| Hydroxyethyl cellulose type 2 | Thickener | 0.013 | 0.013 | | | |
| Ethyl hydroxyethyl cellulose | Thickener | | | 0.060 | 0.055 | 0.055 |
| Biopolymer | Viscosity modifier | | | 0.003 | | |
| Surfactant product (surface-active substances) | Defoamer | 0.100 | 0.100 | | | |
| Nonionic surfactant | Dispersing and | | | 0.150 | | |
| | wetting agent | | | | | |
| Limestone flour | Filler | 20.617 | 19.117 | | | |
| Iron manganese oxide | Black pigment | | 1.500 | 1.500 | 0.300 | |
| TiO2 | White pigment | | | | 0.950 | 0.950 |
| Total | | 100.000 | 100.000 | 100.000 | 100.000 | 100.000 |

*not according to the invention

### Example 2

Formulations 2 and 3 of Example 1 were tested for their suitability for providing decorative colored floor coverings. Both formulations are pigmented with 1.5% black pigment (mixed iron manganese oxide).

For the application, formulation 2 was mixed with water in a ratio of 25 kg/6.0 l water and formulation 3 in a ratio of 25 kg/5.5 l water.

In a preliminary test, both formulations are drawn down onto paperboard using a doctor blade with a layer thickness of 1 mm. After drying, the area obtained with formulation 2 is lighter than that of formulation 3.

Based on the initial results, additional, more extensive areas are set up. Non-absorbent plasterboard boards, primed with a synthetic resin dispersion (Schönox® SDG Plus), serve as the substrate. The processing is carried out exclusively by means of a finishing trowel.

Formulation 2, mixed with the required amount of water, was low-viscosity compared to formulation 3, making it difficult to incorporate the pigments homogeneously. The shade of the floor covering obtained with formulation 2 was lighter than that of formulation 3. Formulation 2 would require more pigment to achieve the same shade.

The floor covering obtained with formulation 2 showed oil eyes, streaking and washouts both after application and after drying. Without wanting to be tied to a theory, it is assumed that the oil eyes are caused by the defoamer contained in formulation 2. On the other hand, the floor covering obtained with formulation 3 showed no oil eyes, streaking or washouts both after application and after drying. With formulation 3, therefore, a decorative floor covering with uniform coloring was obtained largely without visual defects.

The results are summarized in Table 2 below.

TABLE 2

| | Formulation 2 | Formulation 3 |
|---|---|---|
| Consistency after | low-viscosity | higher viscosity |
| mixing with water | | compared to |
| | | formulation 2 |
| Consistency during | low-viscosity | higher viscosity |
| application | | compared to |
| | | formulation 2 |
| Appearance during | oil eyes, streaking, | uniform coloring |
| drying | washouts | |
| Appearance after drying | oil eyes, streaking, | uniform coloring |
| | washouts | |
| Color | lighter than | darker than |
| | formulation 3 | formulation 2 |

### Example 3

Mechanical properties of floor coverings prepared with formulations 3 and 5 of Example 1 were tested and compared with floor coverings made from filling compounds available on the market and containing color pigments, which had a gray color (formulation 6) or a whitish gray color (formulation 7). The results are shown in Table 3 (NKL=standard conditions).

Solidification times were measured according to standard EN 196-3 with a Vicat apparatus. Bending tensile strength and compressive strength were measured according to standard EN 196-1.

TABLE 3

| | Formulation | | | |
|---|---|---|---|---|
| | 6* | 7* | 5 | 3 |
| | Color | | | |
| | gray | whitish gray | whitish gray | gray |
| Mixing ratio | 20 kg/5.2 l | 20 kg/5.2 l | 25 kg/5.25 l | 25 kg/5.25 l |
| | 25 kg/6.5 l | 25 kg/6.5 l | | |

Solidification time [min]

| | | | | |
|---|---|---|---|---|
| Start / End | 78 / 86 | 76 / 86 | 59 / 60 | 60 / 61 |
| | 86 / 100 | 68 / 78 | | |

Bending and compressive strength-indoor climate [N/mm²]

| | | | | |
|---|---|---|---|---|
| 6 h NKL | | | 3.6 / 18.5-18.9 | 3.5 / 16.9-16.4 |
| | | | 3.3 / 17.4-18.7 | 3.4 / 17.0-17.4 |
| 16 h NKL | | | 5.4 / 28.0-24.7 | 4.8 / 29.5-27.0 |
| | | | 5.2 / 27.9-29.0 | 5.1 / 27.5-26.3 |
| 1 d NKL | 3.3 / 12.5-12.3 | 3.5 / 12.5-12.8 | | |
| 7 d NKL | 6.6 / 24.9-25.5 | 6.6 / 24.4-26.8 | 10.3 / 44.7-42.0 | 9.7 / 45.8-41.2 |
| | 6.3 / 23.4-24.1 | 6.0 / 25.2-26.1 | 10.3 / 45.2-47.9 | 9.6 / 42.9-45.4 |
| 28 d NKL | 7.7 / 34.2-34.1 | 7.9 / 36.8-36.5 | 14.1 / 51.6-46.5 | 11.4 / 46.3-52.9 |
| | 7.2 / 34.5-34.9 | 7.9 / 36.0-35.4 | 13.4 / 54.8-50.0 | 12.5 / 45.4-47.7 |
| | | | 13.5 / 45.0-47.6 | |
| 28 d NKL + | | | 18.4 / 52.5-37.7 | 16.2 / 44.1-58.7 |
| 14 d at 50° C. | | | 18.4 / 44.7-56.3 | 16.8 / 56.4-38.3 |

Shrinkage - indoor climate (21° C. and 55% rh)

| | | | | |
|---|---|---|---|---|
| Max. | 0.21 | 0.27 | 0.04 | 0.04 |
| swelling | | | | |
| Shrinkage | −0.47 | −0.45 | −0.36 | −0.29 |
| after 7 d | | | | |
| Shrinkage | −0.51 | −0.48 | −0.34 | −0.28 |
| after 28 d | | | | |

*not according to the invention

In addition, formulation 3 showed a slump spread of 32 cm after 3 min and no bleeding at all.

### Example 4

Formulations 8 to 18 Filling compounds were produced according to formulations 8 to 18 specified in Tables 4 and 6 below, in which different thickening agents and plasticizers as well as different ratios of aluminate binder to calcium sulfate binder were tested. Formulation 8 is according to the invention with PCE as the plasticizer and ethyl hydroxyethyl cellulose as the thickening agent. Formulations 9 to 14 are not according to the invention (9: no thickener, 10: no PCE, 11: different plasticizer, 12: different thickener, 13: no thickener, no plasticizer, 14: different plasticizer, different thickener). Furthermore, formulations 15, 16 and 18 are not in accordance with the present invention (15: aluminate binder:calcium sulfate binder ratio 1:8.2; 16: aluminate binder:calcium sulfate binder ratio 1:0.7; 18: no thickener). Formulation 17 is according to the invention.

In the comparative tests, additives used included BASF's Melment F®245 (superplasticizer), a sulfonated, melamine-based condensation product, as plasticizer, and Bentone®DY-CE, an organically modified smectite clay from Elementis UK Ltd, as thickening agent. Otherwise, the components used correspond largely to those used for formulations 1 to 5. The properties of the formulations were tested in terms of processability and appearance, for which they were mixed with water in a mixing ratio of 25 kg of formulation per 5.25 l of water and then, if processable, the mixed formulations were drawn down onto paperboard using a doctor blade with a layer thickness of 1 mm.

Processability parameters were tested. The flow diameter was measured 3 minutes and 20 minutes after mixing with water in accordance with standard EN 12350-5. The appearance of the applied formulations was evaluated visually. The results are shown in Table 5.

The formulations, which after mixing with water show a thick and tough consistency and become firm, cannot be drawn down onto the substrate. They are unsuitable for the production of floor coverings. Even formulation 12 shows a thick consistency after mixing and is quite firm and therefore does not necessarily tend to bleed or to separate. It is therefore not surprising that it has a relatively good appearance. However, it is also not suitable for the production of a floor covering.

TABLE 4
Formulations 8 to 14

| | | 8 | 9 | 10 | 11 | 12 | 13 | 14 |
|---|---|---|---|---|---|---|---|---|
| | | Parts by | Parts by | Parts by | Parts by | Parts by | Parts by | Parts by |
| Component | Function | weight | weight | weight | weight | weight | weight | weight |
| alpha-Calcium sulfate | Binder | 46.200 | 46.200 | 46.200 | 46.200 | 46.200 | 46.200 | 46.200 |
| hemihydrate | | | | | | | | |
| Chalk | Filler | 7.500 | 7.500 | 7.500 | 7.500 | 7.500 | 7.500 | 7.500 |
| Quartz sand | Filler | 24.517 | 24.517 | 24.517 | 24.517 | 24.517 | 24.517 | 24.517 |
| Calcium sulfate | | 0.250 | 0.250 | 0.250 | 0.250 | 0.250 | 0.250 | 0.250 |
| dihydrate | | | | | | | | |
| Vinyl acetate-ethylene | Redispersible | 1.500 | 1.500 | 1.500 | 1.500 | 1.500 | 1.500 | 1.500 |
| copolymer | powder | | | | | | | |
| Sodium gluconate | Retarder | 0.080 | 0.080 | 0.080 | 0.080 | 0.080 | 0.080 | 0.080 |
| powder | | | | | | | | |
| Lithium carbonate 99% | Accelerator | 0.010 | 0.010 | 0.010 | 0.010 | 0.010 | 0.010 | 0.010 |
| Potassium sodium | Retarder | 0.030 | 0.030 | 0.030 | 0.030 | 0.030 | 0.030 | 0.030 |
| tartrate | | | | | | | | |
| Calcium sulfoaluminate | Binder | 17.750 | 17.750 | 17.750 | 17.750 | 17.750 | 17.750 | 17.750 |
| PCE type 2 | Plasticizer | 0.200 | 0.200 | — | — | 0.200 | — | — |
| Erythritol | Shrinkage | 0.250 | 0.250 | 0.250 | 0.250 | 0.250 | 0.250 | 0.250 |
| | reducer | | | | | | | |
| Ethyl hydroxyethyl | Thickener | 0.060 | — | 0.060 | 0.060 | — | — | — |
| cellulose | | | | | | | | |
| Nonionic surfactant | Dispersing | 0.150 | 0.150 | 0.150 | 0.150 | 0.150 | 0.150 | 0.150 |
| | and wetting | | | | | | | |
| | agent | | | | | | | |
| Iron manganese oxide | Black | 1.500 | 1.500 | 1.500 | 1.500 | 1.500 | 1.500 | 1.500 |
| | pigment | | | | | | | |
| Biopolymer | Viscosity | 0.003 | 0.003 | 0.003 | 0.003 | 0.003 | 0.003 | 0.003 |
| | modifier | | | | | | | |
| Melment F 245 | Plasticizer | — | — | — | 0.200 | — | — | 0.200 |
| Bentone DY-CE | Thickener | — | — | — | — | 0.200 | — | 0.200 |

TABLE 5
Processability of formulations and appearance of products 8-14

| | 8 | 9 | 10 | 11 | 12 | 13 | 14 |
|---|---|---|---|---|---|---|---|
| Mixing time [s] | 60 | 60 | 60 | 60 | 60 | 60 | 60 |
| Waiting time [s] | 180 | 180 | 180 | 180 | 180 | 180 | 180 |
| Powder wetting | ok | ok, a little | thick & | thick & | thick, | thick & | thick & |
| | | thinner | tough | tough | better than | tough | tough |
| | | | | | 8, 9 | | |
| Consistency on mixing | ok | ok, a little | thick & | thick & | thick, | thick & | thick & |
| | | thinner | tough | tough | better than | tough | tough |
| | | | | | 10, 11 | | |
| Consistency after | ok | ok, a little | thick & | thick & | thick, | thick & | thick & |
| mixing | | thinner | tough | tough | better than | tough | tough |
| | | | | | 10, 11 | | |
| Consistency after | ok | ok, a little | thick & | thick & | thick, | thick & | thick & |
| waiting time | | thinner | tough | tough | better than | tough | tough |
| | | | | | 10, 11 | | |
| Consistency after 20 | slightly | ok, a little | thick & | thick & | thick, | thick & | thick & |
| min | thicker | thinner | tough | tough | better than | tough | tough |
| | | | | | 10, 11 | | |
| Flow diameter | 31.0 | 37.0 | n.m., firm | 13.5 | 25.0 | n.m., firm | n.m., firm |
| after 3 min [cm] | | | | | | | |
| Flow diameter | 30.0 | n.m., | n.m., firm | n.m., firm | n.m. | n.m., firm | n.m., firm |
| after 20 min [cm] | | severe | | | | | |
| | | settling | | | | | |
| Bleeding after 15 min | ok | nok | n.m., firm | n.m., firm | ok | n.m., firm | n.m., firm |
| Solidification time | — | 68 | — | — | — | — | — |
| (start) [min] | | | | | | | |
| Solidification time | — | 76 | — | — | — | — | — |
| (end) [min] | | | | | | | |
| Stability in the cup | ok | nok | ok | ok | ok | ok | ok |
| Stability of flow | ok | nok | n.m., firm | n.m., firm | ok | n.m., firm | n.m., firm |
| diameter | | | | | | | |
| Appearance | ok | nok | n.m., firm | n.m., firm | ok | n.m., firm | n.m., firm |

Key:
ok: satisfactory,
nok: not ok,
n.m.: not measurable/determinable

TABLE 6
Formulations 15 to 18

| | | 15 | 16 | 17 | 18 |
|---|---|---|---|---|---|
| | | Parts by | Parts by | Parts by | Parts by |
| Component | Function | weight | weight | weight | weight |
| alpha-Calcium sulfate | Binder | 56.95 | 26.2 | 53.95 | 46.2 |
| hemihydrate | | | | | |
| Chalk | Filler | 7.5 | 7.5 | 7.5 | 7.5 |
| Quartz sand | Filler | 24.13 | 24.13 | 24.13 | 24.73 |
| Calcium sulfate dihydrate | | 0.25 | 0.25 | 0.25 | 0.25 |
| Vinyl acetate-ethylene | Redispersible powder | 1.5 | 1.5 | 1.5 | 1.5 |
| copolymer | | | | | |
| Sodium gluconate powder | Retarder | 0.08 | 0.08 | 0.08 | 0.08 |
| Lithium carbonate 99% | Accelerator | 0.01 | 0.01 | 0.01 | 0.01 |
| Potassium sodium tartrate | Retarder | 0.03 | 0.03 | 0.03 | 0.03 |
| Calcium sulfoaluminate | Binder | 7.0 | 37.75 | 10.0 | 17.75 |
| PCE type 2 | Plasticizer | 0.2 | 0.2 | 0.2 | 0.2 |
| Erythritol | Shrinkage reducer | 0.25 | 0.25 | 0.25 | 0.25 |
| Ethyl hydroxyethyl cellulose | Thickener | 0.60 | 0.60 | 0.60 | — |
| Iron manganese oxide | Black pigment | 1.5 | 1.5 | 1.5 | 1.5 |

The dry mixtures 15-18 were mixed with water in a water:powder ratio of 0.21. Subsequently, processability, appearance, solidification time and strengths were determined as described above.

TABLE 7
Processability of formulations and appearance of products 15 - 18

| | 15 | 16 | 17 | 18 |
|---|---|---|---|---|
| Consistency on mixing | a little | a little | Ok | a little |
| | thicker | thicker | | thinner |
| Bleeding after 15 min | Ok | Ok | Ok | Ok |
| Flow diameter | 31.5 | 30.0 | 33 | 34.0 |
| after 3 min [cm] | | | | |
| Solidification time | 198 | 34 | 130 | 72 |
| (start) [min] | | | | |
| Solidification time | 206 | 40 | 136 | 78 |
| (end) [min] | | | | |
| Bending tensile | 3.1 | 5.0 | 3.3 | 3.8 |
| strength (6 h) [MPa] | | | | |
| Compressive strength | 16 | 31 | 17 | 18 |
| (6 h) [MPa] | | | | |
| Compressive strength | 21 | 45 | 22 | 30 |
| (24 h) [MPa] | | | | |
| Appearance | OK | nok | OK | nok |

Key: ok: satisfactory, nok: not ok, n.m.: not measurable/determinable

### Example 5

Example 5 shows the effect of erythritol and glycerol in a filling compound according to the invention.

Mixtures 5-1 to 5-4 of the invention, as specified in Table 8, were prepared. For this purpose, all the constituents were weighed in the quantities given in Table 8 and thoroughly mixed until a visually homogeneous powder was formed. The specified amount of water was added to this dry mixture and it was mixed on an IKA stirrer at 600 rpm for 60 sec. The resulting mass was poured into prismatic molds of the dimensions shown in Table 8 and allowed to cure under the specified conditions. The shrinkage was measured after the times specified in Table 8.

TABLE 8
Compositions and results for Example 5 (raw materials
in the compositions are specified in g)

| Raw material | 5-1 | 5-2 | 5-3 | 5-4 |
|---|---|---|---|---|
| Portland cement | 0 | 0 | 0 | 0 |
| Calcium sulfoaluminate cement | 18 | 18 | 18 | 18 |
| alpha-Calcium sulfate hemihydrate | 46 | 46 | 46 | 46 |
| Quartz sand | 25.8 | 25.8 | 25.8 | 25.8 |
| Chalk | 7.5 | 7.5 | 7.5 | 7.5 |
| Vinyl acetate-ethylene copolymer | 2 | 2 | 2 | 2 |
| PCE type 2 | 0.2 | 0.2 | 0.2 | 0.2 |
| Ethyl hydroxyethyl cellulose | 0.6 | 0.6 | 0.6 | 0.6 |
| Additives* | 0.1 | 0.1 | 0.1 | 0.1 |
| Erythritol | | 0.1 | 0.25 | 0.50 |
| Water | 22 | 22 | 22 | 25 |

Shrinkage on samples 160 × 40 × 10 mm @ 20° C./55% rh [mm/m]

| | | | | |
|---|---|---|---|---|
| 1 h | +0.07 | −0.05 | −0.03 | −0.05 |
| 24 h | −0.05 | −0.3 | −0.05 | −0.1 |
| 7 d | −0.2 | −0.45 | −0.31 | −0.35 |
| 28 d (end value E) | −0.25 | −0.46 | −0.33 | −0.38 |
| Max. expansion L | +0.18 | −0.05 | −0.03 | −0.05 |
| Ratio L/E | 0.72 | 0.11 | 0.09 | 0.13 |

Shrinkage on samples 160 × 40 × 10 mm @ 20° C./75% rh [mm/m]

| | | | | |
|---|---|---|---|---|
| 1 h | +0.13 | +0.05 | −0.01 | +0.01 |
| 24 h | +0.22 | +0.25 | +0.4 | +0.1 |
| 7 d | +0.17 | +0.2 | +0.23 | +0.21 |
| 28 d | +0.08 | +0.15 | +0.14 | +0.15 |
| Max. expansion L | +0.29 | +0.25 | +0.4 | +0.21 |
| Ratio L/E | 3.63 | 1.67 | 2.85 | 1.4 |

*Additives: Mixture of defoamer (mineral oil), retarder (fruit acid), accelerator (lithium carbonate) and color pigment (iron manganese oxide).

n.m.: not measured

As can be seen from the results in Table 8, the use of erythritol results in a reduction in the L/E ratio. A low L/E ratio means little deformation of the hardening construction chemical composition. This is desirable, since in this way for example the formation of cracks can be avoided.

1. A floor construction on a substrate, comprising a floor covering and a sealing layer applied to the floor covering, wherein one or more primers are arranged between the substrate and the floor covering and the floor covering is formed of a filling compound mixed with water and cured, wherein the filling compound comprises
i) an aluminate binder selected from calcium aluminate cement and/or calcium sulfoaluminate cement,
ii) a calcium sulfate binder selected from calcium sulfate hemihydrate and/or calcium sulfate anhydrite,
iii) one or more fillers,
iv) ethyl hydroxyethyl cellulose as thickening agent,
v) comb polymer, which is a copolymer comprising a polymer backbone and sidechains bonded thereto, and at least one ionizable monomer unit and at least one sidechain-bearing monomer unit are present, wherein the ionic group of the ionizable group is selected from carboxylate, sulfonate, phosphate or phosphonate and the sidechain-bearing monomer unit contains at least one ether group, as plasticizer, and
vi) one or more color pigments as coloring agent,
wherein the amount of filler is 15% to 70% by weight and the total amount of aluminate binder and calcium sulfate binder is 25% to 80% by weight, wherein the weight ratio of aluminate binder to calcium sulfate binder is in the range from 1:1 to 1:8, wherein the weight specifications refer to the dry weight of the filling compound.

2. The floor construction as claimed in claim 1, wherein the content of ethyl hydroxyethyl cellulose is in the range from 0.01% to 0.2% by weight and/or the content of comb polymer is in the range from 0.05% to 0.5% by weight, weight, wherein the weight specifications refer to the dry weight of the filling compound.

3. The floor construction as claimed in claim 1, wherein the filling compound additionally comprises at least one polyol having a functionality of 4 or less and a density of OH groups of at least 0.033 mol OH per g polyol.

4. The floor construction as claimed in claim 1, wherein the ethyl hydroxyethyl cellulose has a particle size d₉₈ of not more than 1000 μm.

5. The floor construction as claimed in claim 1, wherein
the one or more color pigments are selected from white color pigments, black color pigments, chromatic color pigments or mixtures thereof, and/or the one or more fillers comprise sand and/or calcium carbonate.

6. The floor construction as claimed in claim 1, wherein the filling compound comprises:
i) 10% to 30% by weight of the aluminate binder,
ii) 20% to 60% by weight of the calcium sulfate binder and
iii) 15% to 70% by weight of the one or more fillers.

7. The floor construction as claimed in claim 1, wherein
the sealing layer is a plastic seal, and/or
the sealing layer is transparent or translucent.

8. The floor construction as claimed in claim 1, wherein the floor covering has a layer thickness in the range from 1 to 100 mm.

9. (canceled)

10. (canceled)

11. (canceled)

12. (canceled)

13. A method for producing a floor construction on a substrate as claimed in claim 1, comprising
a) applying one or more primers to the substrate,
b) applying a mixture of the filling compound with water to the primed substrate and allowing the mixture to dry, to form the floor covering, and
c) applying a sealing layer to the dried floor covering.

14. A filling compound for the production of a floor covering on a primed substrate, wherein the filling compound comprises
i) an aluminate binder selected from calcium aluminate cement and/or calcium sulfoaluminate cement,
ii) a calcium sulfate binder selected from calcium sulfate hemihydrate and/or calcium sulfate anhydrite,
iii) one or more fillers,
iv) ethyl hydroxyethyl cellulose as thickening agent,
v) comb polymer, which is a copolymer comprising a polymer backbone and sidechains bonded thereto, and at least one ionizable monomer unit and at least one sidechain-bearing monomer unit are present, wherein the ionic group of the ionizable group is selected from carboxylate, sulfonate, phosphate or phosphonate and the sidechain-bearing monomer unit contains at least one ether group, as plasticizer, and
vi) one or more color pigments as coloring agent,
wherein the amount of filler is 15% to 70% by weight and the total amount of aluminate binder and calcium sulfate binder is 25% to 80% by weight, wherein the weight ratio of aluminate binder to calcium sulfate binder is in the range from 1:1 to 1:8, wherein the weight specifications refer to the dry weight of the filling compound.

15. The filling compound as claimed in claim 14, wherein the content of ethyl hydroxyethyl cellulose is in the range from 0.01% to 0.2% by weight and/or the content of comb polymer is in the range from 0.05% to 0.5% by weight, wherein the weight specifications refer to the dry weight of the filling compound.
